(19) United States
(12) Patent Application Publication
(10) Pub. No.: US 2010/0266155 A1
(43) Pub. Date: Oct. 21, 2010

(54) Method and Apparatus for Assembling a Targeted Set of Photographs

(75) Inventors: Fredric Scott Goell, Foster City, CA (US); Lawrence Jacobs, Redwood City, CA (US); Alan Cabrera, El Cerrito, CA (US); Seth Daniel Tager, Oakland, CA (US)

Correspondence Address: PARK, VAUGHAN & FLEMING LLP, 2820 FIFTH STREET, DAVIS, CA, 95618, US

(73) Assignee: Picateers, Inc., San Mateo, CA (US)

(21) Appl. No.: 12/423,946

(22) Filed: Apr. 15, 2009

(51) Int. Cl. G06K 9/00

(52) U.S. Cl. 382/100; 235/375

(57) ABSTRACT

Apparatus and methods are provided for automatically dividing a collection of digital photographs into subject-specific sets. Before an event at which photographs are to be taken, information identifying some or all subjects is submitted to an automated facilitator. The facilitator generates slates comprising machine-scannable tags or codes, with each identified subject having a unique slate. At the event, for each subject a first photo is taken that includes the subject's slate; any number of photos is taken afterward. The photos are uploaded to the facilitator and scanned to identify the slates. Every photo that follows a slate is associated with the corresponding subject, until another slate is identified. Subjects are provided access codes with which to access the facilitator and view their photographs, purchase copies, order merchandise, etc. Access codes may be separate from the slates, or may be human-readable forms of the machine-scannable tag within the slates.

### BACKGROUND

This invention relates to the fields of computer systems and digital photography. More particularly, a method and apparatus are provided for automatically partitioning a set of digital photographs of multiple subjects based on subjects' identities.

When a large number of photographs of different subjects are taken, sorting them and finding particular photos (e.g., of a specific subject) can be very time-consuming. Typically, a human must review all the photos, identify the subject (or subjects) of each one, by name, and manually assemble whatever grouping or compilation is desired.

This process can be difficult even when the event at which the photographs are taken is highly structured, such as a photograph day at a school. Usually, one subject is photographed at a time, possibly with several shots being taken. However, a school administrator or other person still must identify each student's photographs so that they can be separated. Privacy concerns may limit who may review children's photographs and how they are disseminated.

One method of tying photographs to their subjects requires the subjects' names to be manually entered at the time of the photographs. For example, when taking photographs of students, each student's name may be entered into a computing device when it is his or her turn to be photographed.

However, this solution requires additional equipment, may involve a complicated process of preparing the equipment, and may be impracticable for someone who is not a professional photographer, such as a parent or other person who has volunteered to assist with the event.

Thus, current methods of capturing photographs of multiple subjects, dividing them by subject and disseminating them properly is time-consuming and inefficient, thereby serving as an obstacle to enjoying the creation of visual mementos.

### SUMMARY

In some embodiments of the invention, apparatus and methods are provided for automatically dividing a collection of digital photographs into subject-specific sets.

Before an event at which photographs are to be taken, information identifying some or all subjects is submitted to an automated facilitator. The facilitator generates slates comprising machine-scannable tags or codes, with each identified subject having a unique slate.

At the event, for each subject a first photo is taken that includes the subject's slate; any number of photos of the subject may be taken afterward. After the event, the photos are uploaded to the facilitator and scanned to identify the slates. Every photo that follows a slate is associated with the corresponding subject, until another slate is identified.

Subjects may be provided access codes with which to access the facilitator and view their photographs, purchase copies, order merchandise, etc. Access codes may be separate from the slates, or may be human-readable forms of the machine-scannable tag within the slates.

Besides separating photographs by subject, the facilitator may also use subjects' photographs to facilitate creation of identification cards, assemble or layout photos for a yearbook or other compilation, generate a composite collection of photographs of multiple subjects (which may be automatically titled with the subjects' names), or take other action.

In some embodiments of the invention, timestamps associated with photographs (e.g., timestamps generated by the cameras used to take the photographs) may be used to sequence them. Sequencing by time may be applied not only to subject-specific sets of photographs, but also to other (not necessarily subject-specific) collections of photos.

### DESCRIPTION OF THE FIGURES

FIG. 1 is a block diagram depicting an apparatus for automatically partitioning a collection of digital photographs by subject, in accordance with some embodiments of the present invention.

FIG. 2 is a flowchart illustrating one method of automatically partitioning a collection of digital photographs by subject, in accordance with some embodiments of the present invention.

FIG. 3 is a block diagram of apparatus for automatically partitioning a collection of digital photographs by subject, in accordance with some embodiments of the present invention.

FIG. 4 is a block diagram of a facilitator for automatically partitioning a collection of digital photographs by subject, in accordance with some embodiments of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In embodiments of the invention, apparatus and methods are provided for automatically dividing a collection of digital photographs based on their subjects. For each subject, one or more photographs are grouped together for electronic presentation, printing, generating identification cards, assembling a compilation of photographs, etc.

In some embodiments, an automated facilitator receives information identifying the subjects of the photographs before the photographs are taken. For example, for a photograph day at a school, where the subjects are known beforehand, an administrator of the school or an organizer of the event submits the students' identities to the facilitator.

Using the provided identification data, the facilitator generates machine-scannable tags or labels (herein termed slates) for each identified subject. The slates are printed and, during the event, a subject's slate is photographed before or with the first photograph of the subject. After the slate is photographed, any number of images of the corresponding subject may be taken without the slate.

After the event, the photographs are uploaded to the facilitator for processing. The facilitator automatically scans the stream of photographs to identify slates, scans each slate to identify its corresponding subject, and associates photographs that follow the slate with that subject.

Advantageously, all photos of all subjects may be uploaded together, as a single stream or collection. Because the subjects can be identified by their slates, there is no need to maintain a logically grouping of photos that may have been useful if a human was responsible for dividing the photographs.

For example, in a traditional method of segregating photographs after a school's photograph day, each homeroom's or class' photographs may be kept as a separate collection. Doing so would ease the task of a human reviewer in matching photographs to students' names.

In some embodiments of the invention, after dividing the photographs, the facilitator prepares announcements to be distributed to the subjects (or the subjects' families) to inform them that the photographs are ready. The announcements may or may not include sample photographs. The subjects can then connect to the facilitator to view and or order copies of the photographs, and/or other products.

Announcements may include access codes the subjects are to use to access the facilitator, or such access codes may be included in their slates. Illustratively, a subject's access code may match an identifier associated with the subject by the facilitator, and the subject's slate may comprise a graphical (e.g., barcode) representation of that identifier. In other implementations, a subject's access code is separate from his or her slate.

Although some embodiments of the invention are intended for use when the subjects' identities are known before the event at which the photographs are taken, in other embodiments their identities may be provided when, or after, the photographs are submitted to the facilitator.

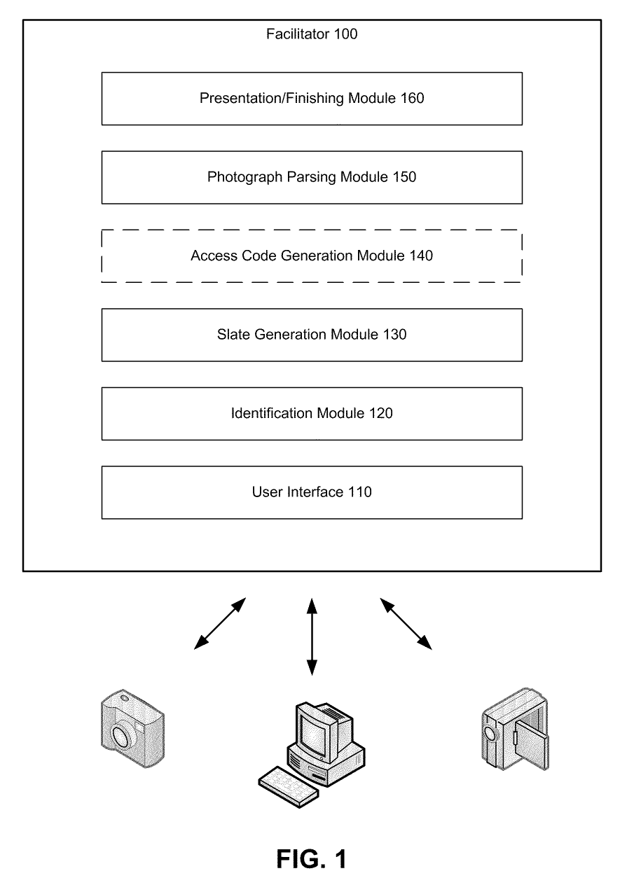

FIG. 1 is a block diagram of a computing environment in which an embodiment of the invention may be implemented. In this embodiment, facilitator 100 is configured with various modules for assisting with preparation for a photographic event, processing photographs taken at the event, and possibly distributing the photographs or facilitating their use in other products (e.g., identification cards, yearbooks, posters, other composites or compilations).

User interface 110 is exposed to and may be used by various entities during methods of the invention. For example, a person or organization planning an event at which photographs will be taken may use the user interface to create flyers or announcements of the event, specify or request operating parameters to be applied by facilitator 100 when it processes photographs from the event, submit a roster identifying the subjects of a collection of photographs, and so on.

An end user may employ the user interface to view photographs, order prints, make payment, etc. For example, for a photograph day at a school, parents of the subjects of the photographs may use user interface 110 to view and/or order photographs of their children, as well as other products (e.g., coffee mugs, tee shirts).

Identification module 120 is configured to receive identities of subjects of photographs that will be or have been submitted to facilitator 100 for processing. To continue with the school photograph day example, an administrator of the school may upload a roster or spreadsheet of students to the facilitator (e.g., via electronic mail, via user interface 110, via file exchange).

Depending on the event associated with the photographs to be processed by facilitator 100, identification module 120 may receive various data regarding the subjects, such as name, a known identifier (e.g., student number, patient number, driver's license number), physical or electron mail address, etc. For a student photograph event, the information may include each subject's grade, homeroom, parent's name, student/parent electronic mail address and/or other data.

Thus, the unique subject identity maintained by identification module 120 may be based on the subject's name, student identification number or some other known identifier, or the identification module may generate a new identifier.

Slate generation module 130 is configured to generate slates for each known subject to be photographed at the event. In particular, for each subject identified to the facilitator by an organizer of the event, the slate generation module generates a unique slate.

As generated, slates may comprise electronic representations of an identifier (e.g., an identity adopted or assigned by identification module 120), without yet being printed into physical form (on paper). Within the slate, the identifier may be depicted as a barcode (one-dimensional or two-dimensional), a glyph, an alphanumeric string, or other label or tag that can be scanned and recognized by a machine (e.g., a barcode reader, a computing device executing an optical character recognition routine).

At some point at or before the event, an organizer or other entity associated with the event prints the slates to create physical forms that can be photographed. Specifically, the electronic versions of the slates may be transmitted to an event organizer from facilitator 100 for local printing at the event site. Alternatively, the slates may be printed by the facilitator and delivered to the event or an event organizer.

Optional access code generator module 140 is configured to generate access codes. In some embodiments of the invention, access codes may be provided to photographic subjects to allow them to electronically access facilitator 100 (e.g., via user interface 110) in order to view their photographs after they have been processed by facilitator 100, order prints or merchandise, or take other action.

In embodiments of the invention in which access codes are employed, the codes may be provided to the subjects after their photographs have been prepared by facilitator 100. The codes may be distributed electronically (e.g., via electronic mail) or physically (e.g., as flyers or letters). Alternatively, an access code may be combined with or within a subject's slate. In this case, the subject may be advised to retain his or her slate and use the specified access code to access the facilitator.

Parsing module 150 is configured to parse a stream or collection of digital photographs and separate it into sets of photographs associated with different subjects. The photographs may be transmitted to facilitator 100 via electronic mail, via user interface 110, via compact disc or in some other manner.

Parsing module 150 includes logic for identifying slates within the stream by automatically scanning each photograph. If a photograph includes a slate, the parsing module identifies the subject associated with the slate (e.g., by cross-referencing the slate with a list of subjects) and starts a new group or set of photographs for that subject. If a photograph does not include a slate, it is automatically added to the previous subject's photographs.

In these embodiments of the invention, no human intervention is needed to parse the stream of photographs and divide it into subject-specific sets. However, if an error is detected or suspected, for example if a threshold number of photographs have been scanned without detecting a slate, human or automated intervention may be warranted, or the photo processing module may re-process some number of photographs.

In some embodiments of the invention, a parsing module may be configured to determine when multiple different slates are included in one photograph and/or when successive photos comprise different slates. In these embodiments this may signify that one or more following photographs comprise all of the subjects associated with those slates.

Presentation module 160 presents a subject's photographs to the subjects (or their representatives) in a suitable manner. Thus, the presentation module may display some or all of the subject's photographs when he or she connects to facilitator 100 (e.g., via user interface 110).

Presentation module 160 may also be configured to print (or assemble for printing) a photograph of a subject to be sent to the subject (or the subject's family) as a notice that the photographs are ready to be accessed at the facilitator. As described above, this notice may include an access code. Yet further, the presentation module may assist an event organizer in preparing for an event, by providing tools for designing a flyer, announcement, or other literature.

The presentation module, or some other module of facilitator 100, may also be configured to facilitate assembly of a compilation of different students' pictures, such as for a yearbook, a student roster that includes pictures, a memento of an event at which the photographs were taken, etc. Photographs used in these compilations can be automatically captioned with the students' names, because each photograph was associated with its subject when received at the facilitator.

One skilled in the art will appreciate that other embodiments of the invention may be derived from FIG. 1 without exceeding the scope of the invention. For example, modules depicted in FIG. 1 may be combined or further separated, or the functions of a facilitator as described above may be distributed among a different composition of modules.

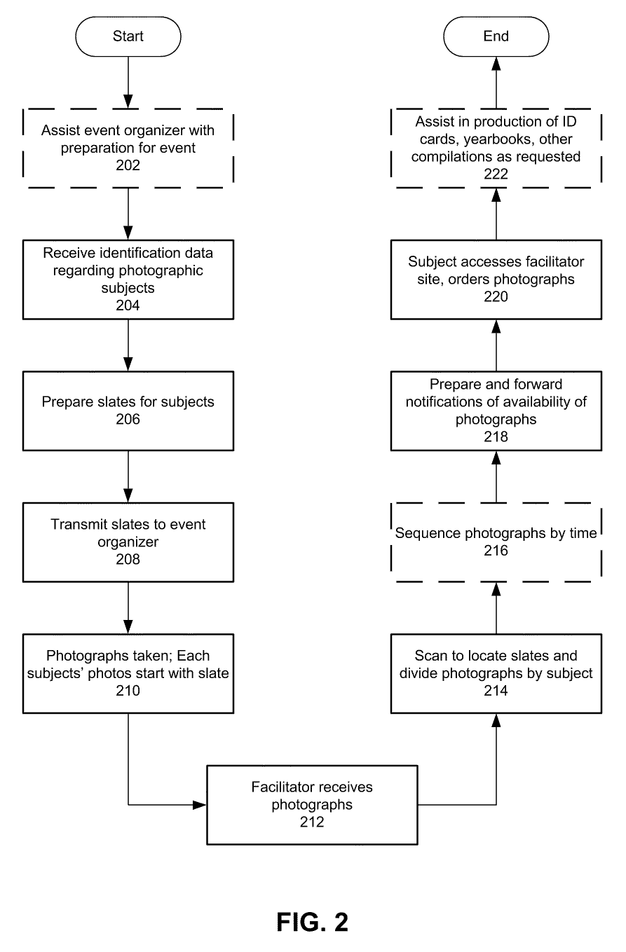

FIG. 2 is a flowchart demonstrating a method of automatically dividing a collection of photographs into separate sets distinguished by subject, according to an embodiment of the invention.

In optional operation 202, an organizer, participant or other person involved with an event at which photographs will be taken connects to a facilitator (such as facilitator 100 of FIG. 1) to prepare material for the event.

For example, the facilitator may assist the organizer with creation of an advertisement or other announcement of the event. The announcements may comprise letters, flyers, posters, brochures, etc. The organizer may print the resulting materials locally, or the facilitator may print the materials and distribute them or send them to the organizer.

In operation 204, the organizer or other entity transmits a list, roster or other set of data identifying some or all of the subjects of photographs to be taken at the event. For example, if the event is a school's photograph day, an administrator of the school may submit rosters for classes that will be photographed. The submitted data may include subjects' names, existing identification numbers (e.g., student ID, driver's license number), class number or name, grade, electronic mail address, and so on.

In operation 206, the facilitator uses the submitted data to prepare individual slates for each identified subject. A subject's slate comprises a machine-scannable tag, code or label that has been assigned to or associated with that subject. Illustratively, the tag may comprise a one- or two-dimensional barcode, a large alphabetic, numeric or alphanumeric string, a graphical pattern, or some other suitable identifier.

In operation 208, the subjects' slates are electronically transmitted to the organizer of the event or some other person associated with the event, and printed. The slates may be transmitted in any suitable textual or graphical form, (e.g., PDF or portable document format, word-processing document, graphics file). In other embodiments of the invention, the facilitator may print the slates and mail or deliver them to the organizer or the event.

In operation 210, photographs are taken of the subjects, with the first photograph for each subject including the subject's slate. The first photo may be of just the slate, or may include the slate and the subject. After the subject's slate is photographed, any number of photos of the subject may be taken. If the subject is photographed again during the event, in the illustrated embodiment of the invention the subject's slate will again be captured.

In operation 212, the photographs are electronically uploaded to the facilitator. Illustratively, the organizer may connect to the facilitator to perform the upload, or may email the photos, send them on a compact disc or other storage device, or submit them in some other manner.

In operation 214, the facilitator scans the photographs to locate slates. The scanning may be a barcode-reading program, an optical character recognition routine, or some other program. Each time a new slate is discovered, the facilitator identifies the subject associated with the slate's tag and prepares to assemble a set of photographs of that subject. When a photograph is scanned and found not to include a slate, it is automatically associated with the subject corresponding to the most recent slate.

The scanning process may proceed in automated fashion unless an error is detected or suspected. For example, if the scanning routine identifies what appears to be a slate, but cannot read it (e.g., part of the tag is obscured), automated or human intervention may be required. For example, a face recognition routine may be executed to determine when the subjects of two sequential photographs are different.

In optional operation 216, each subject-specific set of photographs is ordered by time, based on timestamps or codes associated with the photographs by the camera or cameras that produced them. This process of sequencing images by time may be used in other circumstances in addition to, or instead of, sequencing subject-specific sets of images.

For example, if more than one set of photographs of a subject is available to a facilitator (e.g., a student's photos from more than one photograph day), samples of each set may be combined and sequenced by time to produce a set of subject-specific photographs that span some period of time (e.g., multiple years of school).

As another example, to assist in the production of a yearbook, poster, montage or other compilation of photographs of multiple subjects taken over some period of time (e.g., a school year), the photographs may be sequenced by time.

In operation 218, the facilitator prepares and releases announcements regarding the completion of processing of the photographs. The announcements may be electronically transmitted to the event organizer or directly to the subjects of the photographs (or their representatives/families), or may be printed and distributed.

The announcements indicate that the subjects' photographs are now available at the facilitator, and include access codes for accessing the photographs. An announcement may also include one or more partial or full photographs of the corresponding subject, in full size or miniature.

In some other embodiments of the invention, a subject's slate includes the access code the subject will later be able to use to access his or her photographs via the facilitator. Illustratively, a slate's tag may comprise a machine-scannable form of the access code, along with a printed version of the code that the subject can comprehend.

In these other embodiments, operation 218 may be omitted because the subject already has the access code, and can connect to the facilitator to check if the photos are ready. Or, the facilitator may send an electronic mail message, a text message, an instant message or other electronic communication to alert the subject to the availability of his/her photographs.

In operation 220, a subject (or representative of the subject) connects to the facilitator and enters the corresponding access code. The facilitator then displays some or all of the subject's photographs, and presents offers for selling the photographs in electronic and/or physical form.

The facilitator may also offer other merchandise. For example, the subject may be able to order a tee shirt, mug or other item featuring a photograph of his or her choice.

In optional operation 222, the facilitator uses some or all of the photographs for another purpose, such as generation of identification cards, assembling a compilation of photographs of multiple subjects for a yearbook, a memento of the event, a facebook or montage, or for some other reason. Because information identifying the subjects is available, the photographs used in these other products may be marked with the subjects' names, may be grouped in some logical order (e.g., by class, by grade, by subject name), and so on. An administrator or organizer associated with the photographic event may be able to adjust this ordering as desired and/or amend subjects' names or other data.

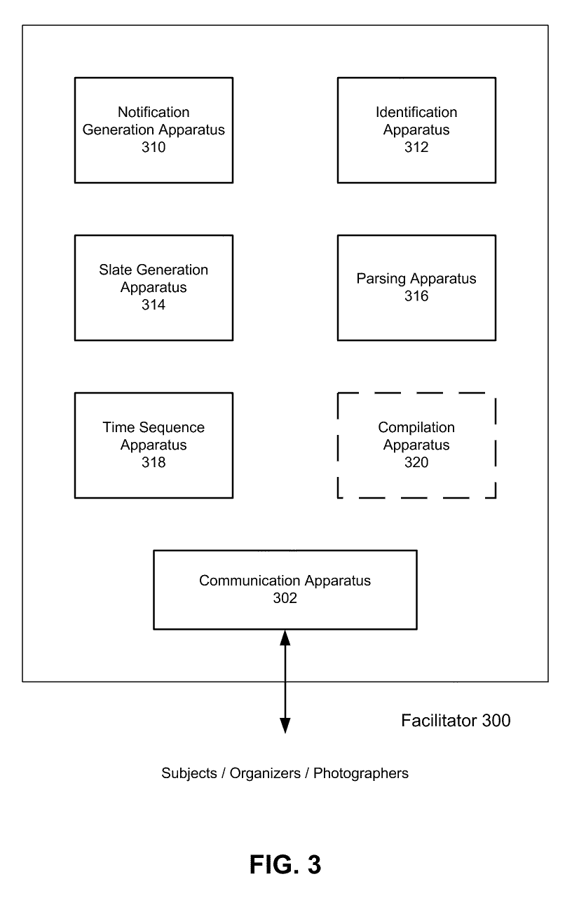

FIG. 3 is a block diagram of hardware apparatus that may be employed to facilitate automatic partitioning of a collection of digital photographs by subject, according to some embodiments of the invention.

Facilitator 300 of FIG. 3 comprises communication apparatus 302 for communicating with subjects, subjects' representatives, photographers, organizers of photographic events and/or other parties. The communication apparatus is adapted to transmit communications to, and receive communications from, external parties. The communication apparatus may also be adapted to assemble/extract components of a communication, and/or to encrypt/decrypt communications as needed.

Communications sent or received via the communication apparatus may include, but are not limited to, slates, access codes, photographs, rosters of photographic subjects, announcements/alerts, etc.

Notification generation apparatus 310 is adapted to generate and transmit notifications (e.g., via communication apparatus 302). The notification generation apparatus may produce or help produce literature regarding a photographic event, alerts indicating availability of photographs at facilitator 300, reminders, etc.

Identification apparatus 312 is adapted to receive and store identities of photographic subjects. As described previously, such identities may be received before a photographic event and used to generate individual slates for each subject.

Slate generation apparatus 314 is adapted to produce subject-specific slates to help separate a collection of digital photographs into subject-specific sets. The slates may comprise barcodes and/or other types of machine recognizable tags or codes.

Parsing apparatus 316 is adapted to scan a collection of digital photographs, which may be uploaded via communication apparatus 302. The parsing apparatus is able to identify subject slates and associate corresponding photographs with the slate's subject.

Time sequence apparatus 318 is adapted to order a number of photographs by time. The time sequence apparatus may rely upon timestamps or other codes generated by cameras that captured the photographs, or by other time indicia. The timestamps or code may therefore have been affixed at the time the photographs were taken, or may be associated with the photographs later.

Optional compilation apparatus 320 is configured to produce or assist in the production of various types of photograph compilations. Such compilations may include, but are not limited to, photographs stored on compact discs (CDs) or other storage media, yearbooks, posters, identification cards, facebooks (e.g., collections of photos of all students in a given class, grade or school), and so on.

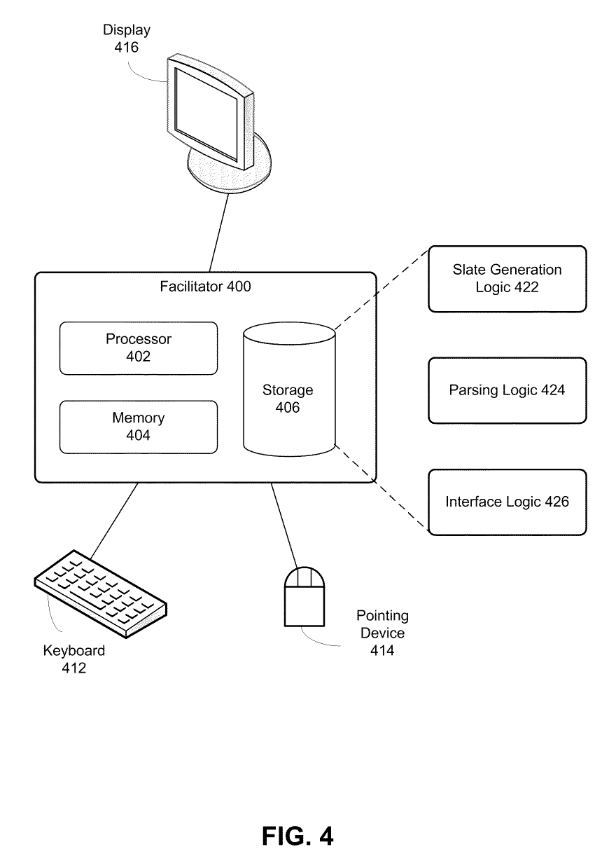

FIG. 4 is a block diagram of a facilitator suitable for automatically partitioning a collection of digital photographs by subject, according to some embodiments of the invention. The facilitator may comprise a file server, a web server, a general-purpose computer system and/or some other type of computing device.

Facilitator 400 of FIG. 4 comprises processor 402, memory 404 and storage 406, which may comprise one or more optical and/or magnetic storage components. Facilitator 400 may be coupled (permanently or transiently) to keyboard 412, pointing device 414 and display 416.

Storage 406 of the network intermediary stores logic that may be loaded into memory 404 for execution by processor 402. Such logic includes slate generation logic 422, parsing logic 424 and interface logic 426.

Slate generation logic 422 comprises processor-executable instructions for generating slates for association with individual photographic subjects, and may also generate access codes to be used to retrieve the subjects' photographs when ready. Illustratively, for each subject identified in a roster or other listing, the slate generation logic may generate an access code and/or slate and associate them with the subject. When a slate is identified in a stream of photographs, or an access code is entered by a subject (or a representative of a subject), the associated subject can be easily identified.

Parsing logic 424 comprises processor-executable instructions for parsing a stream of photographs. Thus, as described above, the parsing logic may scan a series of digital photographs to identify a slate and associate a subsequent series of photographs with the associated subject.

Interface logic 426 comprises processor-executable instructions for facilitating interaction with subjects, subjects' representatives, photographers, organizers of photographic events and/or other parties. Thus, the interface logic may comprise a user interface, one or more web pages, tools for satisfying the parties' needs (e.g., to access photographs, to submit photographs, to prepare for a photographic event, to generate notices regarding photographs), and/or other components.

Storage 406 of facilitator 400 may also comprise other logic (not shown in FIG. 4), for performing other functions described herein.

The environment in which a present embodiment of the invention is executed may incorporate a general-purpose computer or a special-purpose device such as a hand-held computer. Details of such devices (e.g., processor, memory, data storage, display) may be omitted for the sake of clarity.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. An automated method of producing a set of photographs of a selected subject from a collection of photographs of multiple subjects, the method comprising:
generating a scannable tag for each of multiple photographic subjects;
receiving an electronic stream of photographs;
parsing the stream to identify subsets of photographs, wherein different subsets of photographs are characterized by having different subjects;
producing a notification for each subset of photographs, wherein said notification comprises an access code associated with the corresponding subject;
electronically receiving a first access code; and
in response to receipt of the first access code:
identifying the subject associated with the first access code; and
serving one or more photographs from the subset of photographs corresponding to the subject.

2. The method of claim 1, further comprising, prior to said generating a scannable tag:
receiving a roster identifying the photographic subjects.

3. The method of claim 1, wherein said scannable tag comprises a barcode.

4. The method of claim 1, wherein said scannable tag comprises a two-dimensional barcode.

5. The method of claim 1, further comprising:
generating a corresponding slate for each of the multiple subjects, said slate comprising the scannable tag;
wherein a first photograph of each subset of photographs includes the slate corresponding to the subject of the subset of photographs.

6. The method of claim 5, wherein said parsing comprises scanning the stream of photographs for a slate.

7. The method of claim 5, wherein a slate corresponding to a given subject further comprises the access code associated with the subject.

8. The method of claim 1, wherein:
the received photographs include at least one photograph comprising a scannable tag; and
said parsing comprises scanning the stream of photographs to attempt to detect a scannable tag.

9. The method of claim 8, further comprising:
if a scannable tag is found in a parsed photograph:
identifying the subject corresponding to the scannable tag;
defining a new subset of photographs; and
associating the parsed photograph with the identified subject; and
if a scannable tag is not found in a parsed photograph:
associating the photograph with a subject with which a previous photograph in the stream was associated.

10. The method of claim 1, wherein said producing a notification comprises:
facilitating generation of a notification advertising an availability of the subset of photographs.

11. The method of claim 10, wherein said notification is specific to the corresponding subject of the subset of photographs.

12. The method of claim 10, wherein said notification comprises one or more photographs from the subset of photographs.

13. The method of claim 1, further comprising:
for each subject, generating an identification card comprising a photograph of the subject.

14. The method of claim 1, further comprising:
for each subject, assembling information configured to facilitate generation of an identification card comprising a photograph of the subject.

15. The method of claim 1, further comprising:
generating a compilation of photographs from multiple different subsets of photographs.

16. A computer-readable medium storing instructions that, when executed by a computer, cause the computer to perform a method of producing a set of photographs of a selected subject from a collection of photographs of multiple subjects, the method comprising:
generating a scannable tag for each of multiple photographic subjects;
receiving an electronic stream of photographs;
parsing the stream to identify subsets of photographs, wherein different subsets of photographs are characterized by having different subjects;
producing a notification for each subset of photographs, wherein said notification comprises an access code associated with the corresponding subject;
electronically receiving a first access code; and
in response to receipt of the first access code:
identifying the subject associated with the first access code; and
serving one or more photographs from the subset of photographs corresponding to the subject.

17. An electronic method of producing a set of photographs of a selected subject from photographs of multiple subjects, the method comprising:
receiving identifications of multiple subjects to be photographed;
generating identifiers corresponding to the multiple subjects;
electronically receiving and storing a digital stream of photographs of at least a portion of the identifiers and the multiple subjects;
for each of the multiple subjects:
detecting the subject's corresponding identifier in the digital stream of photographs;
associating the subject with a set of photographs from the stream of photographs, wherein the set of photographs feature the subject; and
generating a notification regarding the set of photographs, wherein the notification includes an associated access code; and
in response to electronic receipt of an access code, producing the associated set of photographs.

18. The method of claim 17, wherein an identifier comprises a visual tag.

19. The method of claim 18, wherein:
the visual tag comprises a barcode; and
said detecting comprises scanning a photograph to identify the barcode.

20. The method of claim 17, wherein a subject's corresponding identifier comprises the access code to be associated with the subject's set of photographs.

21. The method of claim 17, further comprising, prior to said generating identifiers:
facilitating generation of an announcement of an event at which photographs may be taken of the multiple subjects.

22. An apparatus for automatically presenting sets of photographs from a stream of photographs of multiple subjects, wherein each set of photographs features a different subject, the apparatus comprising:
an identification module configured to receive identities of the multiple subjects;
a slate module configured to generate slates for the multiple subjects, wherein each slate comprises a machine-readable tag associated with one subject;
a parsing module configured to parse the stream of photographs to identify the sets of photographs; and
a presentation module configured to present one or more photographs from a set of photographs.

23. The apparatus of claim 22, further comprising:
a user interface configured to assist a user in preparing for an event at which the photographs are taken.

24. The apparatus of claim 22, wherein said identification module is configured to receive a roster identifying the multiple subjects.

25. The apparatus of claim 22, wherein the machine-readable tags comprise barcodes.

26. The apparatus of claim 22, wherein the machine-readable tags comprise two-dimensional barcodes.

27. The apparatus of claim 22, wherein the parsing module is configured to scan the stream of photographs for the slates.

28. The apparatus of claim 22, wherein a first photograph of each subject comprises the slate.

29. The apparatus of claim 28, wherein the parsing module is configured to:
detect the machine-readable tag in the first photograph for a given subject; and
associate all subsequent photographs in the stream with the given subject until a different machine-readable tag is detected.

30. The apparatus of claim 22, further comprising:
a code module configured to generate an access code for each subject;
wherein the presentation module presents the one or more photographs upon receipt of the access code.

31. The apparatus of claim 30, wherein each slate further comprises the access code for the associated subject.
